(19) United States
(12) Patent Application Publication
(10) Pub. No.: US 2024/0010191 A1
(43) Pub. Date: Jan. 11, 2024

(54) LOW CLEARANCE WARNING FOR VEHICLES

(71) Applicant: Robert Bosch GmbH, Stuttgart (DE)

(72) Inventor: Michael T. White, Livonia, MI (US)

(21) Appl. No.: 17/862,156

(22) Filed: Jul. 11, 2022

(51) Int. Cl. B60W 30/09; B60W 30/095; B60W 50/14; B60W 10/18; B60W 40/06; B60W 40/105

(52) U.S. Cl. CPC B60W 30/09; B60W 30/0956; B60W 50/14; B60W 10/18; B60W 40/06; B60W 40/105; B60W 2050/146; B60W 2300/12; B60W 2420/52; B60W 2530/205; B60W 2552/35; B60W 2554/80; B60W 2556/35

(57) ABSTRACT

A low clearance detection system for a vehicle. In one example, the system includes a first sensor configured to detect an object in front of the vehicle and generate an object clearance signal. The system includes a second sensor configured to detect a load height of a load of the vehicle and generate a load height signal. The system includes a third sensor configured to detect a distance between the third sensor to a ground surface and to generate a ground reference signal. The system also includes an electronic processor configured to receive the object clearance signal, the load height signal, and the ground reference signal. The electronic processor determines an object clearance threshold, a clearance height of the load, and a load collision condition when the clearance height exceeds the object clearance threshold. In response to determining the load collision condition, the electronic processor controls a vehicle system.

### FIELD

Embodiments described herein relate to a low clearance warning system for vehicles.

### SUMMARY

Many vehicles, such as trucks, are configured to haul or transport loads. One aspect of a vehicle load is a vertical height, such as the height of a freight container or a load on a truck flatbed. It may be desirable for the vehicle to include a clearance warning associated with the vertical height. Therefore, embodiments described herein provide, among other things, systems and methods of low clearance warning.

In some embodiments, a low clearance detection system for a vehicle includes a first sensor, the first sensor configured to detect an object in front of the vehicle and generate an object clearance signal. The system includes a second sensor, the second sensor configured to detect a load height of a load of the vehicle and generate a load height signal. The system also includes a third sensor configured to detect a distance between the third sensor to a ground surface and to generate a ground reference signal. The system also includes an electronic processor configured to receive the object clearance signal from the first sensor, receive the load height signal from the second sensor, and receive the ground reference signal from the third sensor. The electronic processor is further configured to determine an object clearance threshold based on the object clearance signal, determine a clearance height of the load based on the load height signal and the ground reference signal, compare the object clearance threshold to the clearance height of the load, determine a load collision condition when the clearance height of the load exceeds the object clearance threshold and, in response to determining the load collision condition, control a vehicle system.

In some embodiments, a low clearance detection system for a vehicle includes a first sensor, the first sensor configured to detect an object in front of the vehicle and generate an object clearance signal. The system also includes a second sensor, the second sensor configured to detect a load height of a load of the vehicle, and generate a load height signal. The second sensor further configured to detect a distance between the second sensor to a ground surface and to generate a ground reference signal. The system also includes an electronic processor configured to receive the object clearance signal from the first sensor, receive the load height signal from the second sensor, and receive the ground reference signal from the second sensor. The electronic processor is further configured to determine an object clearance threshold based on the object clearance signal, determine a clearance height of the load based on the load height signal and the ground reference signal, compare the object clearance threshold to the clearance height of the load, determine a load collision condition when the clearance height of the load exceeds the object clearance threshold, and in response to determining the load collision condition, control a vehicle system.

Some embodiments provide a method of clearance detection for a vehicle. The method includes receiving, at a controller, object clearance data from a first sensor, receiving, at the controller, load height data from a second sensor, and receiving, at the controller, ground reference data from the second sensor. The method further includes determining, via the controller, an object clearance threshold based on the object clearance data, determining, via the controller, a clearance height of the load based on the load height data and the ground reference data, and comparing, via the controller, the object clearance threshold to the clearance height of the load. The method also includes determining, via the controller, a load collision condition in response to the calculated clearance height of the load exceeding the object clearance threshold, and in response to determining the load collision condition, controlling a vehicle system.

Other aspects, features, and embodiments will become apparent by consideration of the detailed description and accompanying drawings.

### BRIEF DESCRIPTION OF THE DRAWINGS

FIG. 1 is a low clearance warning system for vehicles, according to some examples.

FIG. 2 is a low clearance warning system for vehicles, according to some examples.

FIG. 3 is a low clearance warning system for vehicles, according to some examples.

FIG. 4 is a system of low clearance warning for vehicles, according to some examples.

FIG. 5 is a process of low clearance warning for vehicles, according to some examples.

FIG. 6 is a process of low clearance warning for vehicles, according to some examples.

### DETAILED DESCRIPTION

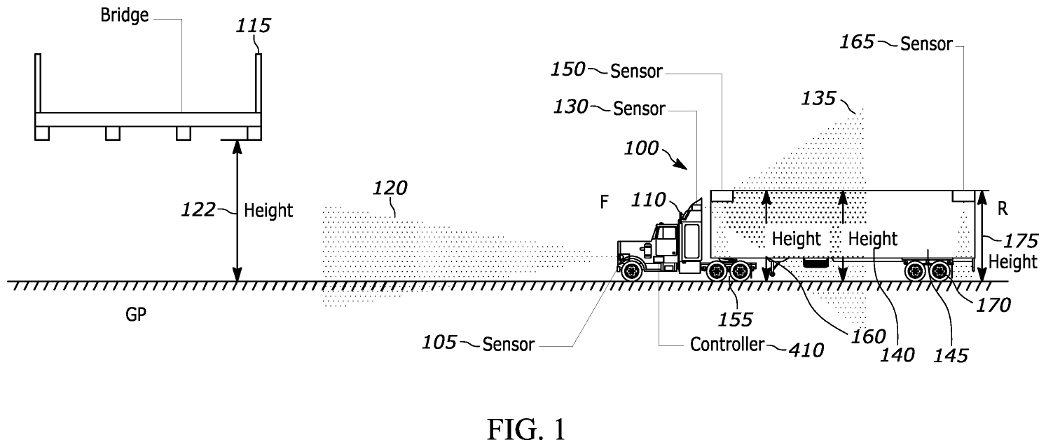

FIG. 1 illustrates a low clearance warning system 100 for vehicles, according to some examples. In the example illustrated, components of the system 100 are mounted or otherwise installed on a vehicle 110. In some cases, the low clearance warning system 100 includes a first sensor 105 configured to detect an object. In the example shown, the first sensor 105 is positioned so that it detects objects in a front F of the vehicle 110. Examples of objects that may be located in front of the vehicle 110 include a bridge 115, a garage door (not shown), a tunnel (not shown), an overhanging sign (not shown), or another object or infrastructure with a clearance height under which vehicles may pass. In some examples, first sensor 105 is a headway sensor, a radar sensor, a lidar sensor, an image sensor, or another type of sensor configured to detect an object. In some examples, the first sensor 105 is a forward-facing radar sensor mounted to the front of the vehicle 110 and is configured to generates a radio signal and receives reflections of those objects in a field of view 120. In some instances, the first sensor 105 is configured to detect a height 125 of the bridge 115 based on one or more reflections.

In the illustrated example, the system 100 includes a second sensor 130. In some examples, second sensor 130 is similar to first sensor 105, but is positioned to detect objects to the rear R of the vehicle 110. In one aspect, second sensor 130 is configured to detect objects in a field of view 135 and configured to detect a height 140 of a load 145 of the vehicle 110 based on one or more reflections of radio signals generated by the second sensor 130. The load 145 of the vehicle 110 may be, for example, a shipping container, a cargo container, or the like. In one aspect, the system 100 also includes a third sensor 150, similar to first sensor 105 and second sensor 130. In some examples, third sensor 150 is placed at the top-front of the load 145 of the vehicle 110 and positioned in a ground-facing orientation. In this example, third sensor 150 has a field of view 155 such that third sensor 150 detects a distance to ground 160 (again based on one or more reflections). In some examples, a fourth sensor 165, similar to the third sensor 150, is placed at the top-rear of the load of the vehicle 145 and configured in a ground-facing orientation. The fourth sensor 165 has a field of view 170 and is configured to detect a distance to ground 175. In some examples, the distance to ground 160 detected by the third sensor 150 is the same as the distance to ground 175. In other examples, the distance to ground 160 and distance to ground 175 are different.

The first sensor 105 is configured to generate and output an object clearance signal associated with the object detected by the first sensor 105. For instance, when the first sensor 105 detects the height 122 of the bridge 115 in front of the vehicle 110, the first sensor generates an object clearance signal associated with the height 122 of the bridge 115. In some cases, the object clearance signal includes information about a height of the bridge with reference to a ground level underneath the bridge. In other aspects, the object clearance signal includes a width of the opening underneath the bridge, positions of support beams of the bridge, or other information detected by the first sensor 105. The first sensor 105 and second sensor 130 are configured to communicate with a controller, such as controller 410 that is described in greater detail below. For instance, the first sensor 105 generates the object clearance signal and the second sensor 130 generates a load height signal associated with the height of the load 145 of the vehicle 11, and both signals are communicated to the controller 410.

The third sensor 150 and the fourth sensor 165 operate similarly and are both configured to communicate with controller 410. Both the third sensor 150 and the fourth sensor 165 are positioned at the top of the of the load 145 of the vehicle 110 and configured in a ground-facing orientation. In some instances, only one of the third sensor 150 and the fourth sensor 165 are mounted on the load 145 of the vehicle 110. In other instances, additional sensors are used. In some examples, third sensor 150 is configured to generate a ground reference signal associated with ground surface conditions detected by the third sensor 150. These ground conditions may include, among other things, road surface conditions, road roughness, an uneven road, potholes, and the like.

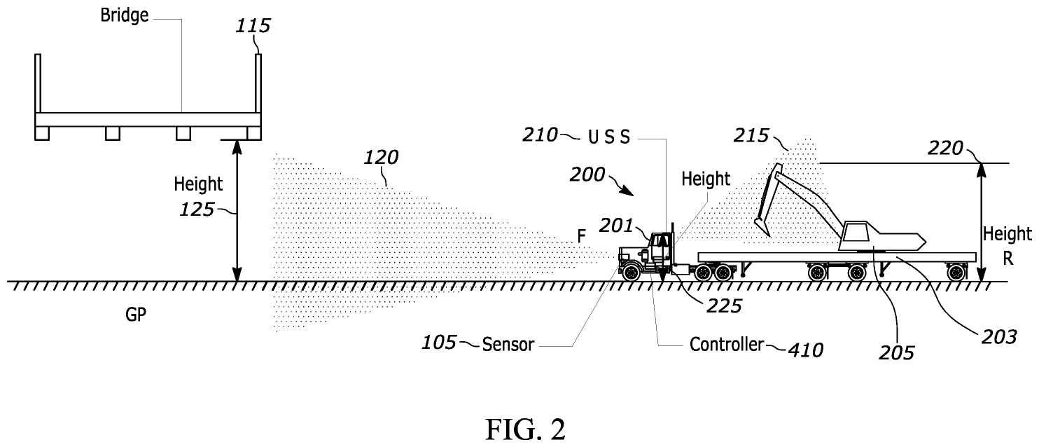

FIG. 2 illustrates a low clearance warning system 200 for vehicles, according to other examples and aspects. The system 200 is similar to system 100 and also includes a vehicle 201 carrying a load 205, which in one instance is a track hoe or excavator. In the example provided, the vehicle 201 includes a flatbed trailer 203 for hauling the load 205. In some instances, the load of the vehicle has an unusual, nonuniform, or variable shape or contour. Similar to the system 100, the system 200 includes controller 410, and the first sensor 105 that is configured to detect a height 125 of the bridge 115. The system 200 also includes a second sensor 210. In some embodiments, second sensor 210 is similar to second sensor 130, and is configured to detect a height 220 of the load 205 of the vehicle 201. In some instances, the second sensor 210 is configured to determine the shape or contour of the load 205 of the vehicle 201. In some examples, the second sensor 210 is programmed with a known height 225 of the vehicle 201. In these instances, the second sensor may use the known height 225 of the vehicle 201 as a reference for determining the total height of the load 205 with respect to a ground plane GP.

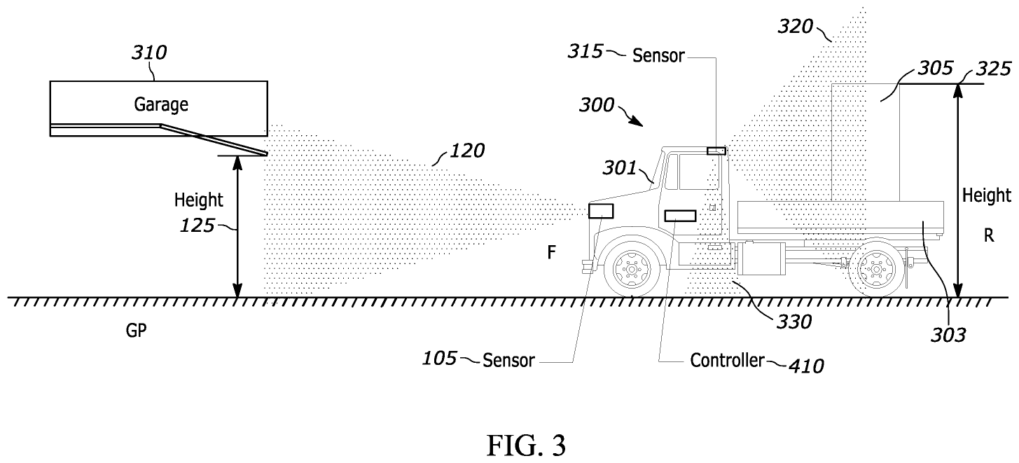

FIG. 3 illustrates a low clearance warning system 300 for vehicles according to still other examples and aspects. The system 300 is similar to previously described systems and includes a vehicle 301 carrying a load 305. Unlike the systems shown in FIGS. 1 and 2, there is no trailer attached to the vehicle 301. The vehicle 301 includes a bed 303 for hauling a load 305. The system 300 includes the first sensor 105, controller 410, and a second sensor 315 that has a field of view 320 and that is configured to detect a height 325 of a load of the vehicle 301. In some examples, second sensor 315 may include some or all of the functionality of third sensor 150 or fourth sensor 165. For example, second sensor 315 may be configured to project ground-facing radar 330 such that second sensor 315 detects a height 325 of the load of the vehicle.

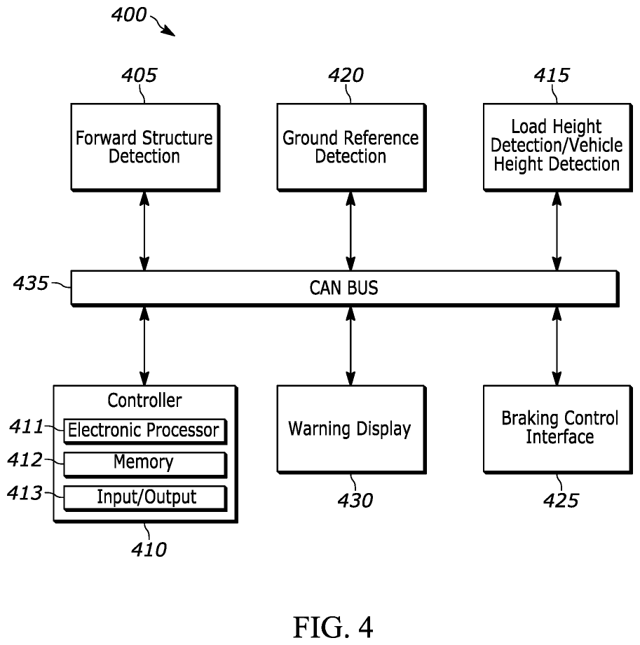

FIG. 4 illustrates electronic components of a system 400 of low clearance warning for vehicles. In some examples, the system 400 includes some of the same sensors as the previously described systems. The system 400 includes the controller 410. In the example shown, controller 410 includes an electronic processor 411, a memory 412, and an input/output interface 413. In some examples, electronic processor 411 is implemented as a microprocessor with separate memory, for example the memory 412. In other examples, the electronic processor 411 may be implemented as a microcontroller (with memory 412 on the same chip). In other examples, the electronic processor 411 may be implemented using multiple processors. In addition, the electronic processor 411 may be implemented partially or entirely as, for example, a field-programmable gate array (FPGA), an applications specific integrated circuit (ASIC), and the like and the memory 412 may not be needed or be modified accordingly. In some examples detailed herein, the memory 412 includes non-transitory, computer-readable memory that stores instructions that are received and executed by the electronic processor 411 to carry out method described herein including methods of road surface detection. The memory 412 may include, for example, a program storage area and a data storage area. The program storage area and the data storage area may include combinations of different types of memory, for example read-only memory and random-access memory. The input/output interface 102 may include one or more input mechanisms and one or more output mechanisms (for example, general-purpose input/outputs (GPIOs), a controller area network bus (CAN) bus interface, analog inputs digital inputs, and the like). The controller 410 is electrically and communicatively connected to a forward structure detection sensor 405, a load height detection and/or vehicle height detection sensor 415, a ground reference detection sensor 420, a braking control interface 425, and a warning display 430. In some cases, there are direct connections between a sensor and the controller 410. In other case, the sensors, warning display 430, and braking control interface 425 are connected to controller 410 via a CAN bus 435, a LIN bus, or another suitable communication bus.

The forward structure detection sensor 405 is similar to first sensor 105 and is configured to generate an object clearance signal that represents an object detected by the forward structure detection sensor 405. The forward structure detection sensor 405 is configured to transmit the object clearance signal to controller 410.

The sensor 415 may be configured similarly to second sensor 130 or second sensor 210. The sensor 415 is configured to project rear-facing radar to detect a height of a load of the vehicle and/or a height of the vehicle. The ground reference detection sensor 420 is similar to third sensor 150 and is positioned in a ground-facing orientation to project ground-facing radar. In some examples, the sensor 420 detects road conditions, such as a rough road, an uneven road, a gravel road, a smooth paved road, and the like. The sensor 420 is also configured to generate ground reference signal, similar to the third sensor 150, and transmit the ground reference signal to the controller 410. The ground reference detection sensor 420 is provides the load height signal and the vehicle height signal to the controller 410.

The braking control interface 425 connects to a vehicle braking system, such as an antilock braking system (ABS), an electronic stability control (ESC) system, a dynamic rear proportioning (DRP) system, a traction control system (TCS), or the like.

The warning display 430 may include a heads-up display, a touch screen interface, lights on a dashboard of the vehicle, a vehicle infotainment system, or the like. In some embodiments, the warning display 430 is configured to display information generated by controller 410. For example, the controller 410 receives both a load height signal from sensor 415 and a forward structure detection signal from sensor the forward structure detection sensor 405. The controller 410 then compares the load height signal and the forward structure detection signal to determine if the load height is greater than the forward structure opening. This comparison is then displayed on the warning display 430. The warning display may also be configured to show one or more thresholds of clearance. For example, if the load height is within a certain first threshold of the forward structure opening, a first warning may be displayed on the warning display 430. If the load height is within a certain second threshold of the forward structure opening, the second threshold being greater than the first threshold, then a second warning may be displayed on the warning display. In these instances, the warnings illustrate degrees of clearance for the load of the vehicle and the opening detected by the forward structure sensor. In some instances, the warning display 430 is configured to display road surface conditions, detected infrastructure height, load height from ground, total vehicle height, distance to the detected infrastructure, or the like.

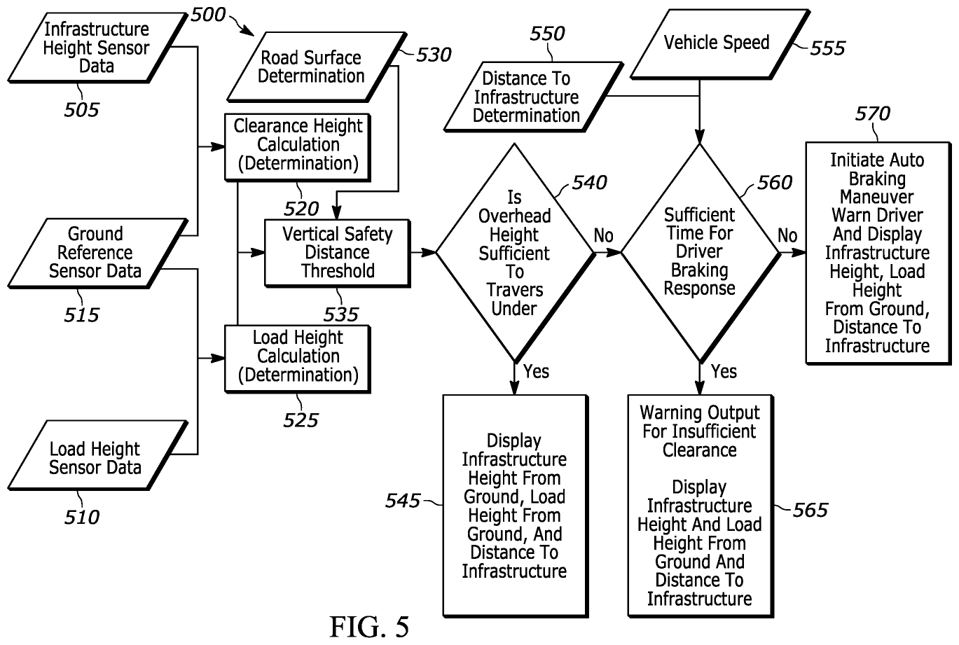

FIG. 5 is a flowchart of a process 500 of low clearance warning for vehicles, according to some examples. In some examples, the process 500 is performed by a controller, such as controller 410. The process 500 includes step 505, receiving infrastructure height sensor data from a sensor such as first sensor 105, step 510, receiving load height sensor data from a sensor such as second sensor 130, and step 515, receiving ground reference sensor data from a sensor such as third sensor 150 or fourth sensor 165. In some examples, infrastructure height sensor data includes data indicative of a distance between the detected infrastructure object and the vehicle. In some examples, ground reference sensor data includes road surface conditions, such as a rough or uneven road. The road surface conditions are used in process 500 step 530, as discussed below. Step 520 includes using the infrastructure height sensor data and the ground reference sensor data to calculate a clearance height. For example, in some instances, the controller 410 calculates the total clearance of a detected infrastructure object using the infrastructure height and the ground reference sensor data. Process 500 also includes step 525, where the load height sensor data and the ground reference sensor data are used by the controller to calculate a load height. For example, the controller 410 calculates the total load height of a load of the vehicle using the load height and the ground reference sensor data.

As previously discussed, in some instances, ground reference sensor data includes road surface conditions. Step 530 of the process 500 includes a road surface determination. For example, controller 410 determines that a road surface is rough and uneven using the ground reference sensor data obtained in step 515. Process 500 also includes step 535, where a controller calculates vertical safety distance threshold using the clearance height calculations, load height calculations, and the road surface determination. For example, in some instances, controller 410 determines that a detected infrastructure object with a calculated clearance height will require a vertical safety distance threshold of 3.0 feet to account for a rough and uneven road condition. Vertical safety distance threshold may range from inches to feet, such as from 1.0 inch to 10.0 feet. Other examples include additional vertical safety distance thresholds.

The process includes step 540, where the controller 410 determines if the vehicle and load heights are sufficiently large enough for the vehicle to safely traverse beneath the detected infrastructure object. If the controller 410 determines that the vehicle height and/or the load height is less than the vertical safety distance threshold, then, in step 545, the controller 410 controls the warning display 430 to display the infrastructure object height from ground, the load height from ground, and the distance from the vehicle to the infrastructure object. On the other hand, if the controller 410 determines that the vehicle height and/or the load height is greater than or equal to the vertical safety distance threshold, the process proceeds to step 560, as discussed below.

The process 500 includes step 550, where the controller 410 determines a distance to infrastructure using the infrastructure height sensor data, as previously discussed. The process 500 also includes step 555, where the controller 410 receives a vehicle speed. The process includes 560, where the controller 410 uses the vehicle speed and the distance to the infrastructure to determine if there is sufficient time for a driver braking response. For example, the controller 410 may receive a vehicle speed of 30 miles per hour and a distance to infrastructure of 250 feet. The controller 410 then determines whether or not there is sufficient time for a driver braking response. If controller 410 determines that there is sufficient time for a driver braking response, the controller 410 controls, in step 565, the warning display 430 to display the infrastructure object height from ground, the load height from ground, the distance from the vehicle to the infrastructure object, and a warning notice that a collision is imminent. The warning notice may be a light, sound, tactile response, or other alarm output by the warning display 430. For example, in some instances, if controller 410 determines that a collision between the vehicle and the detected infrastructure object is imminent and that a driver has sufficient time for a driver braking response, controller 410 controls warning display 430 to sound an audible alarm and flash a visible light. In some examples, higher vehicle speeds require a greater amount of time for a driver braking response. In these instances, the controller 410 determination occurs at a greater distance between the vehicle and the infrastructure.

On the other hand, if controller 410 determines that there is not sufficient time for a driver braking response, then, in step 570, the controller 410 controls the warning display 430 an audible, visual, or tactile response in addition to controlling the vehicle braking system to initiate an automatic braking maneuver. For example, controller 410 receives a vehicle speed of 30 miles per hour and a distance to infrastructure of 25 feet and determines that there is insufficient time for a driver braking response and initiates an automatic braking maneuver in order to bring the vehicle to a stop before a collision occurs. In some examples, the sufficient time for a driver braking response is a predetermined threshold and may vary depending on the vehicle, load weight, load size, or other such conditions. The controller 410 is configured to initiate an automatic braking maneuver at a range of distances and a range of speeds, such as between 1.0 foot and 1,000 feet, or between 5.0 miles per hour and 120 miles per hour.

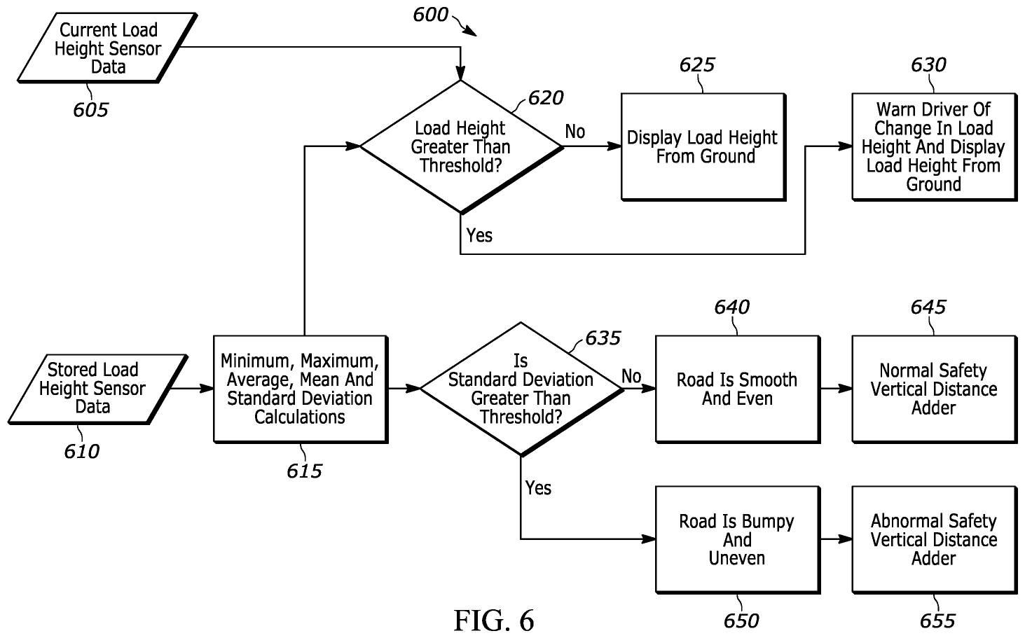

FIG. 6 is a flowchart of a process 600 of low clearance warning for vehicles, according to some examples. The process 600 is similar to the process 500, where a control 410 receives signals from sensors 405, 415, 420. The process 600 includes step 605, where the controller 410 receives a current load height sensor data, such as from second sensor 130. As previously mentioned, in some examples, load height sensor data includes ground reference data. In some instances, the controller 410 stores the current load height sensor data in a memory, such as memory 412 of controller 410. In step 610 load height sensor data is recalled from memory 412 and used by the controller 410. In some examples, such as in step 615, the controller 410 uses the load height sensor data in clearance calculations or statistical calculations, such as minimum, maximum, average, mean or standard deviation calculations. In some examples, these calculations are used to determine dynamic changes in load height from a ground reference, such as changes that occur as a vehicle traverses bumpy or uneven terrain. In step 620, the controller 410 compares the load height sensor data to a vertical safety distance threshold. In some examples, this comparison is similar to the previously described process 500. When the controller 410 determines that the load height is not greater than the vertical safety distance threshold, then, in step 625, the controller 410 controls the warning display 430 to display the load height from ground. When the controller 410 determines that the load height is greater than the vertical safety distance threshold, then, in step 630, the controller 410 controls the warning display 430 to warn the driver of a change in load height in addition to displaying the load height from ground.

The process 600 also includes step 635, where the controller determines if a previously calculated standard deviation of the load height sensor data is greater than a threshold. When the controller 410 determines, in step 640, that the standard deviation is not greater than a threshold, then the controller 410 determines that the road conditions are smooth and even. In some instances, smooth and even road conditions are indicative of a normal road, and in step 545, controller 410 uses a normal safety vertical distance adder when calculating the vertical safety distance threshold. However, when the controller 410 determines that the standard deviation is greater than the threshold, in step 650, the controller 410 determines that road conditions are bumpy and uneven. In some instances, bumpy and uneven road conditions are indicative of an abnormal road, and in step 655, controller 410 increase the vertical distance adder or use an abnormal safety distance adder when calculating the vertical safety distance threshold. In some examples, the vertical distance adder is a dynamic calculation made by the controller 410 as road conditions change during vehicle travel. For instance, as the vehicle travels over a road, the road conditions may change. In these instances, the vertical safety distance threshold is increased or decreased to meet the changing road conditions.

In some examples, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Accordingly, various implementations of the systems and methods described herein provide, among other things, techniques for a low clearance warning system for vehicles. Other features and advantages of the invention are set forth in the following claims.

In the foregoing specification, specific examples have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

What is claimed is:

1. A low clearance detection system for a vehicle, the system comprising:
a first sensor, the first sensor configured to detect an object in front of the vehicle and generate an object clearance signal;
a second sensor, the second sensor configured to detect a load height of a load of the vehicle, and generate a load height signal;
a third sensor configured to detect a distance between the third sensor to a ground surface and to generate a ground reference signal;
an electronic processor configured to:
receive the object clearance signal from the first sensor,
receive the load height signal from the second sensor,
receive the ground reference signal from the third sensor,
determine an object clearance threshold based on the object clearance signal,
determine a clearance height of the load based on the load height signal and the ground reference signal,
compare the object clearance threshold to the clearance height of the load,
determine a load collision condition when the clearance height of the load exceeds the object clearance threshold; and
in response to determining the load collision condition, control a vehicle system.

2. The system of claim 1, wherein the vehicle system is a vehicle braking system.

3. The system of claim 1, wherein the vehicle system is an infotainment system.

4. The system of claim 2, wherein the electronic processor is further configured to:
receive, from the first sensor, a distance between the vehicle and an object in front of the vehicle,
receive a speed of the vehicle,
determine a driver braking response threshold based upon the distance between the vehicle and the object in front of the vehicle and the speed of the vehicle,
control a warning display system of the vehicle in response to the determination that the driver braking response threshold has been exceeded; and
control a vehicle braking system in response to the determination that the driver braking response threshold has been exceeded.

5. The system of claim 1, the system further comprising a fourth sensor configured to detect a distance between the fourth sensor to a second ground surface and to generate a second ground reference signal;
wherein the fourth sensor is placed at a different location on the load of the vehicle from the placement location of the third sensor.

6. The system of claim 5, wherein the electronic processor is further configured to determine a clearance height of the load based on the load height signal, a first ground reference signal generated by the third sensor and a second ground reference signal generated by the fourth sensor.

7. A low clearance detection system for a vehicle, the system comprising:
a first sensor, the first sensor configured to detect an object in front of the vehicle and generate an object clearance signal;
a second sensor, the second sensor configured to detect a load height of a load of the vehicle, and generate a load height signal;
the second sensor further configured to detect a distance between the second sensor to a ground surface and to generate a ground reference signal;
an electronic processor configured to:
receive the object clearance signal from the first sensor,
receive the load height signal from the second sensor,
receive the ground reference signal from the second sensor,
determine an object clearance threshold based on the object clearance signal,
determine a clearance height of the load based on the load height signal and the ground reference signal,
compare the object clearance threshold to the clearance height of the load,
determine a load collision condition when the clearance height of the load exceeds the object clearance threshold; and
in response to determining the load collision condition, control a vehicle system.

8. The system of claim 7, wherein the vehicle system is a braking system.

9. The system of claim 7, wherein the vehicle system is an infotainment system.

10. The system of claim 7, wherein the electronic processor is further configured to:
receive a distance between the vehicle and an object in front of the vehicle,
receive a speed of the vehicle,
determine a driver braking response threshold based upon the distance between the vehicle and the object in front of the vehicle and the speed of the vehicle,
control a warning display system of the vehicle in response to the determination that the driver braking response threshold has been exceeded; and
control a vehicle braking system of the vehicle in response to the determination that the driver braking response threshold has been exceeded.

11. The system of claim 7, the system further comprising a third sensor configured to detect a distance between the third sensor to a second ground surface and to generate a second ground reference signal;
wherein the third sensor is placed at a different location on the load of the vehicle from the placement location of the second sensor.

12. The system of claim 11, wherein the electronic processor is further configured to determine a clearance height of the load based on the load height signal, a first ground reference signal generated by the third sensor and a second ground reference signal generated by the fourth sensor.

13. A method of clearance detection for a vehicle, the method comprising:
receiving, at a controller, object clearance data from a first sensor;
receiving, at the controller, load height data from a second sensor;
receiving, at the controller, ground reference data from the second sensor;
determining, via the controller, an object clearance threshold based on the object clearance data;
determining, via the controller, a clearance height of the load based on the load height data and the ground reference data;
comparing, via the controller, the object clearance threshold to the clearance height of the load;
determining, via the controller, a load collision condition in response to the calculated clearance height of the load exceeding the object clearance threshold; and
wherein response to determining the load collision condition, controlling a vehicle system.

14. The method of claim 13, the method further comprising:
receiving, at the controller, a distance between the vehicle and an object in front of the vehicle;
receiving, at the controller, a speed of the vehicle;
determining, via the controller, a driver braking response threshold based upon the distance between the vehicle and the object in front of the vehicle and the speed of the vehicle;
in response to the determination that the driver braking response threshold has not been exceeded, controlling a warning display system of the vehicle; and
in response to the determination that the driver braking response threshold has been exceeded controlling a vehicle braking system of the vehicle.

15. The method of claim 13, wherein the method further comprises:
determining, via the controller, a vertical safety distance threshold based upon the ground reference data; and
modifying, via the controller, the object clearance threshold based upon the vertical safety distance threshold.

16. The method of claim 13, wherein the ground reference data includes data indicating at least one ground surface condition selected from a group consisting of road surface conditions, road roughness, an uneven road, and potholes.

17. The method of claim 15, wherein the object clearance threshold is modified by increasing the vertical safety distance threshold.
